(19) United States
(12) Patent Application Publication
(10) Pub. No.: US 2024/0154430 A1
(43) Pub. Date: May 9, 2024

(54) BATTERY MANAGEMENT SYSTEM WITH CONTROLLED REPLACEMENT

(71) Applicant: REON Technology, Inc., Chelmsford, MA (US)

(72) Inventors: Xuanhang Zhang, Austin, TX (US); Tiegeng Ren, Westford, MA (US)

(73) Assignee: REON Technology, Inc., Chelmsford, MA (US)

(21) Appl. No.: 18/385,439

(22) Filed: Oct. 31, 2023

Related U.S. Application Data
(60) Provisional application No. 63/536,514, filed on Sep. 5, 2023.
(60) Provisional application No. 63/534,791, filed on Aug. 25, 2023.
(60) Provisional application No. 63/422,464, filed on Nov. 4, 2022.

(51) Int. Cl. H02J 7/00; H01M 10/42

(52) U.S. Cl. CPC H02J 7/0013; H01M 10/425; H01M 2010/4271

(57) ABSTRACT

Techniques for a battery management system with controlled replacement are disclosed. A plurality of battery units is configured. Each battery unit is connected in series to a power bus through a switch in each anode power connection and each cathode power connection of each battery unit. The switch in the anode power connection of each battery unit and the switch in the cathode power connection of each battery unit comprise a battery unit switch pair. Each battery unit switch pair is electronically controlled by a master controller. A power shunt switch is connected across each battery unit switch pair. Each power shunt switch is electronically controlled by the master controller and enables the power bus to bypass a selected battery unit. A signal communication path is provided between the master controller and each battery unit. An in situ battery unit reconfiguration is effected, using the master controller.

### RELATED APPLICATIONS

This application claims the benefit of U.S. provisional patent application “Battery Management System With Controlled Replacement” Ser. No. 63/422,464, filed Nov. 4, 2022, “Distributed Power System For Management And Control” Ser. No. 63/534,791, filed Aug. 25, 2023, and “Battery Management System With Low Latency” Ser. No. 63/536,514, filed Sep. 5, 2023.

Each of the foregoing applications is hereby incorporated by reference in its entirety.

### FIELD OF ART

This application relates generally to battery management and more particularly to a battery management system with controlled replacement.

### BACKGROUND

The remarkable advances in battery technologies, particularly in rechargeable battery technologies, are enabling consumers to communicate more, to enjoy streaming media for longer times, and to travel farther distances than was possible even a few years ago. These battery technology advances enable the user experience, or “UX”, to be greatly enhanced for personal electronic devices such as smartphones, tablets, and computers; vehicles such as cars, buses, and even e-bikes; and other products containing batteries. The user experience is enhanced by these new batteries because the personal electronic devices and vehicles that use them now operate longer and charge faster than did previous models. The proliferation of rechargeable batteries has also accelerated advancements in remote computing. The improved batteries have created entirely new markets for energy storage and usage, replaced old markets, and even generated new product categories. Desktop computers which once dominated the computer market have been largely supplanted by laptop computers and handheld devices. These latter devices enhance the computing experience because the individuals can continue to work and play while on the move. In fact, portable electronic devices and laptop computers can be used for business or recreational purposes essentially anywhere: in airports; on planes, trains, or buses; in coffee shops; or while sitting on the beach in Maui.

The designs, uses, and features of portable devices have greatly advanced with commensurate energy consumption, thus demanding better battery performance. Unfortunately, energy density in battery technology has generally not kept the same pace of improvement, and at times stymies further device design improvements. Thus, energy efficiency of electronic designs remains critical. At the same time, consumers demand portability and reliability from their electronic devices. Today, just about every user device, whether cellphone, laptop, tablet, watch, and so on, requires a battery such as a rechargeable battery. Consumer purchase behavior is strongly influenced by expanded device capabilities that are enabled and facilitated by the improved rechargeable batteries. In fact, consumer purchase decisions are not only influenced by device performance metrics, but also by device usage factors such as portability and battery life. Beyond personal electronic devices, batteries play critical roles in many other aspects of everyday life. In residences, disposable batteries are found in flashlights, clocks, pet trainers, remote controls, etc. Batteries also play safety roles in home medical equipment, safety equipment such as smoke and CO detectors, and by providing battery backup for critical electrical and electronic equipment. Further, all public buildings in the United States are legally required to have lighted emergency signage such as exit signs which highlight the path to safety in case of a fire or other emergency. The batteries ensure that the safety signs illuminate brightly, even when the building's grid power fails. Likewise, battery-powered safety equipment can be found on boats, airplanes, and other vehicles. As the electronic technologies continue to advance, batteries will continue to play a central role in enabling new applications, increasing mobility, and keeping individuals safe.

### SUMMARY

Disclosed techniques include a battery management system with controlled replacement of battery units. A plurality of reclaimed battery cells can be grouped to form one or more battery units. The battery units also include electronically controlled switches. The switches can be configured to combine the battery units into columns made up of units in series. The columns can be arranged in parallel by additional electronically controlled switches, creating a battery system. The battery system can provide primary, supplemental, or backup power for homes, businesses, electrical and electronic equipment, etc. Each battery unit further includes a local controller. The local controller can scan one or more sensors associated with each battery unit to sense battery unit performance characteristics. The performance characteristics include temperature, current, voltage, impedance, and so on. The battery unit performance characteristics are communicated in real time to a master controller using a signal communication path. The master controller can configure the plurality of battery units based on the performance characteristics, energy load requirements, and the like. The performance information can be collected while the battery units are in use. The battery units can be selected using the electronically controlled switches when in use by the battery system or for recharging. The battery units can be deselected when a battery unit is unneeded in a particular battery configuration, or when the battery unit is inadequate to the task. A battery unit can be deemed inadequate by the master controller based on charge leakage, diminished energy delivery, elevated battery cell temperature, combustion risk, etc. The inadequate battery unit can be removed and replaced. Battery unit replacement is controlled by the master controller and is initiated by pressing a button integrated into the battery unit to be replaced. Frequent monitoring of the battery cells within battery units can detect problems with one or more cells such as overheating, a short circuit, etc. Thus, problematic cells can be quickly removed from service and safely discharged, thereby reducing or eliminating the risk of fire or explosion.

A plurality of battery units is configured, where each battery unit of the plurality of battery units is connected in series to a power bus through a switch in each anode power connection of each battery unit and through a switch in each cathode power connection of each battery unit. The switch in the anode power connection of each battery unit and the switch in the cathode power connection of each battery unit comprise a battery unit switch pair. Each battery unit switch pair is electronically controlled by a master controller. A power shunt switch is connected across each battery unit switch pair. Each power shunt switch is electronically controlled by the master controller, and each power shunt switch enables the power bus to bypass a selected battery unit. A signal communication path is provided between the master controller and each battery unit. An in situ battery unit reconfiguration is effected using the master controller.

A processor-implemented method for a battery management system is disclosed comprising: configuring a plurality of battery units, wherein each battery unit of the plurality of battery units is connected in series to a power bus through a switch in each anode power connection of each battery unit and through a switch in each cathode power connection of each battery unit, wherein the switch in the anode power connection of each battery unit and the switch in the cathode power connection of each battery unit comprise a battery unit switch pair, and wherein each battery unit switch pair is electronically controlled by a master controller; connecting a power shunt switch across each battery unit switch pair, wherein each power shunt switch is electronically controlled by the master controller, and wherein each power shunt switch enables the power bus to bypass a selected battery unit; providing a signal communication path between the master controller and each battery unit; and effecting an in situ battery unit reconfiguration, using the master controller. In embodiments, a to-be-replaced battery unit, from the plurality of battery units, is controlled such that the switch pair of the to-be-replaced battery unit is opened and the shunt switch of the to-be-replaced battery unit is closed. Some embodiments comprise reconfiguring the plurality of battery units to remove the to-be-replaced battery unit. Some embodiments comprise additionally reconfiguring the plurality of battery units to add a new battery unit.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a battery management system with controlled replacement.

FIG. 2 is a flow diagram for battery unit handling.

FIG. 3 shows battery unit replacement initiation and removal.

FIG. 4 illustrates battery unit replacement.

FIG. 5 shows battery unit replacement completion.

FIG. 6 is a system block diagram for managing controlled replacement.

FIG. 7 is a system diagram for a battery system management with controlled replacement.

### DETAILED DESCRIPTION

Corporate business practices and consumer purchasing choices are changing radically due to concerns relating to climate change. Environmental changes are being experienced globally, causing corporations and individuals to adopt the guiding principles of “reduce, reuse, and recycle”, known collectively as the three Rs. More than half of US states require businesses and private citizens to recycle at least one material, such as separating the recyclable material from waste that goes to a landfill. Consumer interest in purchasing used items or items made from recycled materials has helped to conserve materials. Reusable plastic or metal water bottles are popular alternatives to disposable water bottles and plastic cups. Many restaurants have replaced plastic straws with paper or washable steel straws, and more patrons are bringing their own straws if desired. While these and other changes have been significant, carbon emission reduction has come to the fore in environmental conversations. No industry has received more pressure to reduce carbon emissions than automobile manufacturers. While improving gas mileage has traditionally been a focus of the industry, recent technological advancements have made possible hybrid, hybrid plug-in, and fully electric vehicles which significantly reduce overall carbon emissions. At the same time, the increase in electrically powered vehicle usage has caused an increase in used batteries which contain hazardous materials. Power generation and electronic devices of all types have the unintended consequence of producing used batteries, adding to the problem of environmental pollution.

A battery management system can provide primary, supplemental, or backup energy to energy consumers ranging from enterprises to individuals. The battery management system can use a master controller to control an energy storage system. The energy storage system can be assembled from battery units, where the battery units comprise recycled battery cells. The master controller can be used to control, define, and configure the energy storage system using electronically controlled switches. These switches are used to configure the energy storage system as needed to meet energy load demands. The master controller can further process battery unit performance characteristics that can be provided by a local controller associated with each battery unit. The battery unit performance characteristics can be communicated in real time between the local controller and the master controller using a provided signal communication path. The master controller can accomplish real-time power capability adjustment of the energy storage system by performing in situ battery unit reconfiguration. The in situ battery unit reconfiguration can include adding battery units to provide additional energy, disconnecting or bypassing unneeded battery units, and so on. The real-time power capability adjustment provides matching between battery unit performance and battery management system load requirements.

An energy storage system can be comprised of batteries of various types. The battery types can be based on a variety of rechargeable battery technologies, such as those batteries widely used in consumer, medical, and other products. For example, every portable electronic device such as a smartphone, laptop computer, tablet computer, smartwatch, and so on, contains a rechargeable battery. Further, the rise in popularity of hybrid, hybrid plug-in, and fully electric vehicles has greatly expanded reliance on, and user confidence in, larger rechargeable batteries. Some uses for rechargeable batteries are found behind-the-scenes. For example, renewable energy storage systems use large batteries to provide power to power grids when renewable sources are offline. Whether obvious or hidden, all rechargeable batteries age over time, primarily due to charge/discharge cycling. As a result, the rechargeable battery systems are unable to meet the technical specifications provided by the manufacturer and the batteries require replacement. New batteries must be installed, and the replaced batteries pose significant problems for the environment due to the metals and chemicals that make up the batteries. For the new batteries, additional lithium must be mined, consuming massive amounts of water, harming soil, and causing air contamination. The batteries that have been removed from equipment can start fires if not stored properly. In many cases, however, the replaced batteries are still capable of storing and delivering energy, and if the batteries can be confirmed safe, they can be redeployed in new applications.

The disclosed method for a battery management system includes techniques for effective control and delivery of power as needed to power loads. The battery management system controls a plurality of battery units configured into a battery system using electronically controlled switches. The battery system can include and reuse existing rechargeable batteries that have been removed from their original service in a variety of products such as electric vehicles. The reuse of the recovered batteries directly reduces old battery waste. Rechargeable batteries that are removed from service can be provided a “second life”. The batteries can be scanned to collect performance information and to determine usability and capacity. New power applications can use the recovered batteries by adding electronically controlled switches to select or deselect the battery units that make up the battery system. The battery units can be selected when in use by the battery system or for recharging, or deselected when the battery unit is unneeded or inadequate for a particular battery configuration. Scanners or sensors can also be added to the cells to monitor cell voltage, numbers of charge/discharge cycles, battery unit “health”, and so on. Frequent monitoring of the battery units can detect problems with one or more battery cells within the battery units, such as overheating, a low impedance such as a short circuit, etc. Thus, problematic battery units can be quickly removed from service and safely discharged, thereby reducing or eliminating the risk of fire or explosion. The removed battery units can be replaced with units that are substantially similar to the removed units or substantially different from the removed cells.

The battery units can be assembled into a disparate battery system comprising a plurality of battery units. The battery units can be selected for use or recharging, or can be bypassed when unneeded or being prepared for battery unit replacement. The battery units and a plurality of electronically controlled switches can comprise battery columns containing battery units coupled in series. The columns can be connected in parallel using additional electronically controlled switches. The disparate battery system can include rechargeable batteries such as lithium-ion batteries that have been removed from vehicles, energy storage devices, personal electronic devices, and so on. These batteries can be considered used, “previously used”, preowned, “second life”, second hand, or can be described with some other terminology denoting a second usage. Battery unit characteristics can be collected by local controllers associated with each of the battery units. The local controllers can collect sensor data from sensors associated with the battery units. The battery unit characteristics can be used to generate battery unit profiles, where the profiles can be used to store information about the battery units. Information obtained from the battery system can include temperature, current, voltage, impedance, number of cycles, and so on. Communication with the master controller and the local controllers associated with the battery units can be accomplished using a provided signal communication path. The signal communication path can be based on an Industrial Internet of Things (lloT) capability. The master controller can handle queries such as battery system capability, energy availability for output, and so on. Further queries handled by the master controller can include a power request with parameters which can include voltage requirements; power requirements; changing direction of current flow to charge or discharge the battery units, columns, system, etc.; changing the voltage output of the system; balancing energy storage between multiple battery systems; responding to a power grid demand; and so on. The battery system can be reconfigured in situ using the master controller. The in situ battery unit reconfiguration can enable real-time power capability adjustment for the plurality of battery units. The power capability adjustments can include energy storage capacity, energy delivery capacity etc. The reconfiguration can further enable removal and replacement of a battery unit. The battery unit replacement can be initiated by a button press of a button associated with the battery unit to be replaced. The removed battery unit can be replaced with a substantially similar battery unit or a substantially different battery unit.

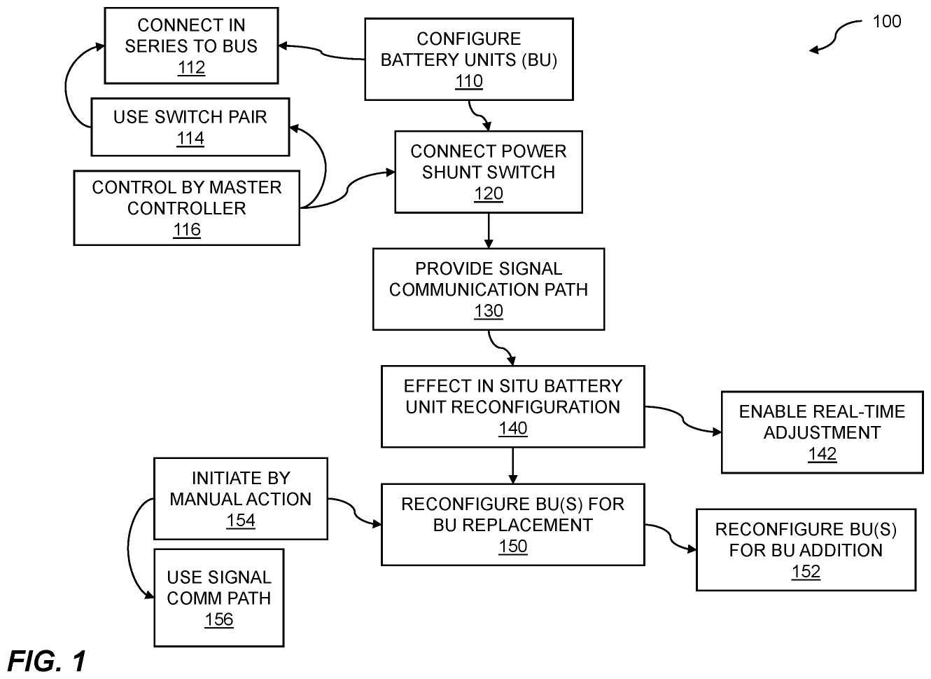

FIG. 1 is a flow diagram for a battery management system with controlled replacement. A battery system comprised of any combination of new or used battery units can be configured by a master controller using electronically controlled switches. The switches can connect the battery units into columns of units connected in series. The switches can also connect the columns in parallel to comprise the battery system. The electronically controlled switches can further connect or bypass each battery unit. The connecting can be accomplished using switch pairs that connect or disconnect battery unit terminals to a power bus. The bypassing can be accomplished using a shunt switch to bypass the battery unit. The connecting or bypassing can be based on a power system configuration, where the configuration includes voltage and current levels, run times, etc. Battery unit performance information can be obtained on the battery units within the battery system including battery unit profile, safety information, temperature, current, voltage, impedance, charge/discharge cycle count, and so on. Information on the battery system can be provided by local controllers within each battery unit to the master controller. The master controller can reconfigure the battery system in situ to match management system load requirements. The battery system reconfiguration can be based on removing, replacing, or adding battery units, power request parameters, and so on.

The flow 100 includes configuring 110 a plurality of battery units. The battery units can be configured into columns by connecting the battery units in series using electronically controlled switches. The connecting the battery units in series can attain a desired output voltage for a battery system. The columns of battery units can further be connected in parallel using electronically controlled switches. The electronically controlled switches can include solid-state switches. The connecting the battery units in series can attain a desired output current for the battery system, a desired run time for the system, and so on. In the flow 100, each battery unit of the plurality of battery units is connected in series 112 to a power bus through a switch in each anode power connection of each battery unit and/or through a switch in each cathode power connection of each battery unit and/or a combination of switch pairs (anode and cathode) and individual switches. Those individual switches can be in either an anode power connection or a cathode power connection, on a per battery unit basis. Embodiments include a processor-implemented method for a battery management system comprising: configuring a plurality of battery units, wherein each battery unit of the plurality of battery units is connected in series to a power bus through a switch in an anode power connection or a switch in a cathode power connection, of each battery unit, and wherein each battery unit switch is electronically controlled by a master controller; connecting a power shunt switch across each battery unit switch and corresponding battery unit, wherein each power shunt switch is electronically controlled by the master controller, and wherein each power shunt switch enables the power bus to bypass a selected battery unit; providing a signal communication path between the master controller and each battery unit; and effecting an in situ battery unit reconfiguration, using the master controller.

The battery units can be formed from battery cells, where the battery cells can include rechargeable batteries such as lithium-ion batteries that have been removed from vehicles, energy storage devices, personal electronic devices, and so on. These batteries can be considered used, “previously used”, preowned, “second life”, recovered, etc., in addition to new or unused batteries. In embodiments, the plurality of battery cells includes lithium-ion battery cells. Other types of rechargeable cells can be included, such as sealed lead-acid (SLA), nickel-cadmium (NiCd), nickel-metal hydride (NiMH), lithium-polymer (LiPo), lithium-iron-phosphate (LiFePO4), solid-state, sodium ion, zinc based, etc. The battery cells may include battery profiles. The battery cell profile can include a variety of information associated with a battery cell including information on aging, brand, or specification. In embodiments, the profiles include manufacturing date; batch number; serial number; in-service date; removed-from-service date; notations about observed wear, cracks, or damage; etc. The profiles can be uploaded by a user, downloaded from a library or repository, and so on. The profiles can be determined while the battery system is in use. In the flow 100, the switch in the anode power connection of each battery unit and the switch in the cathode power connection of each battery unit comprise a battery unit switch pair 114. The switch in each anode power connection and the switch in each cathode power connection can be operated in tandem such that the anode power connection and the cathode power connection can be either both open or both closed. When the switch pair is in the open position, the battery unit is isolated from the power bus, and when the switch pair is in the closed position, the battery unit is connected to the power bus. In the flow 100, each battery unit switch pair is electronically controlled 116 by a master controller. The master controller can control electronically controlled switches, such as the switch pairs, in order to configure the battery system. The configuration can include setting battery system to meet voltage, current, and run time, etc., targets.

The master controller can base the battery system configuration on battery unit profiles, battery unit performance characteristics, power load requirements, and the like. The battery system configuration can be based on power request parameters. The power request parameters can include changing the direction of current flow to charge or discharge the battery cells within the battery units, battery unit columns, battery system, etc.; changing the voltage output of the system; balancing energy storage between multiple battery systems; responding to a power grid demand; and so on. The power request parameters can also include voltage, power, total energy, external system operating requirements, internal system operating requirements, user settings, user preferences, and so on. The configuration of battery cells and columns within the system can be controlled by the master controller, a user, an external system, etc. to achieve the power request parameters. In embodiments, adjustments can be accomplished dynamically. The system configuration can include an inverter to convert the DC voltage associated with the battery system to AC voltage. In some embodiments, the system configuration can include a DC-to-DC converter.

The flow 100 includes connecting 120 a power shunt switch across each battery unit switch pair. The power shunt switch can be used to include a battery unit for use within the battery system or to bypass the battery unit. The bypassing the battery unit can be based on the battery unit not being required within a battery system configuration to meet battery system voltage, current, or runtime requirements. The bypassing the battery unit can be used when the battery unit is operating below performance requirements, failing, experiencing elevated temperature or decreased battery cell impedance, designated for service, and so on. Each power shunt switch is electronically controlled by the master controller. The controlling of the power shunt switch can be coordinated with the controlling the switch pair such that when the battery shunt switch is open, the switch pair is closed, or when the power shunt switch is closed, the switch pair is open. Deadtime control is implemented to prevent both the bypass shunt switch and the switching pair from being open or closed at the same time. Each power shunt switch enables the power bus to bypass a selected battery unit. The bypassing can be used to exclude the selected battery unit from a configuration, to prepare the battery unit for replacement (discussed below), and the like.

The flow 100 includes providing 130 a signal communication path between the master controller and each battery unit. The signal communication path can be based on one or more communications techniques such as wired techniques, wireless techniques, fiber-based techniques, and so on. The communications techniques can include Ethernet™, EtherNet/IP™ EtherCAT™, 802.11, Zigbee™, near-field communication (NFC), and so on. The communications standards can also include fiber distributed data interface (FDDI), fiber channel, asynchronous transfer mode (ATM), etc. The communications techniques can further include industrial internet of things (Industrial IoT, IIoT).

The flow 100 can include effecting 140 an in situ battery unit reconfiguration, using the master controller. The battery unit reconfirmation can be implemented by selectively opening or closing shunt switches, switch pairs, and so on. The reconfiguration can be based on changes in battery unit characteristics, power load fluctuations, and so on. The reconfiguration can be in response to a request such as request from a user, an external system request, and so on. The request can also originate from a battery cell battery unit or a column or system failure. The reconfirmation can further be based on balancing energy storage between battery cells, units, columns, systems, etc.; a voltage level; temperature; current; etc. The request can result from energy loads exceeding a threshold, storage capacity, safety limits, and so on. The reconfiguring can include a different voltage arrangement for charging battery units than a voltage arrangement for discharging battery units. The reconfiguring can adjust the voltage down for charging to, for example, 40V, 50V, and so on. Likewise, the reconfiguring can increase the battery system voltage for providing energy to, for example, 600V, 900V, and the like. The reconfiguring can be accomplished dynamically. A built-in electrical design can be provided within the electronically controlled switches (e.g., flyback diodes) to smooth voltage and current spikes and avoid damage to appliances and other loads. In embodiments, the master controller initiates the effecting, based on the battery unit performance and a software-defined system goal. The software-defined system goal can be provided by a user, downloaded over a computer network, and so on. The software-defined system goal can include voltage and current requirements, operating temperature ranges, a duration of time for providing energy without recharging battery units, etc.

The reconfiguration can be based on negotiating subsequent power parameters based on both the set of power request parameters received and the information on the battery system. The negotiating can be accomplished during run time. The negotiating can be based on a target voltage; current; duration; safety factors; a predefined voltage such as 48 volts, 80 volts, 120 volts, 480 volts, 800 volts, 1000 volts, or some other voltage; etc. The negotiating can be in response to changes in battery unit voltages as the battery units discharge. In the flow 100, the in situ battery unit reconfiguration enables real-time power capability adjustment 142 for the plurality of battery units. The real-time capability can be based on an amount of stored energy remaining within the battery system, an amount of energy available for recharging battery units, changing loads, etc. In embodiments, the real-time power capability adjustment can provide matching between battery unit performance and battery management system load requirements. The real-time power capability adjustment can be used to prolong energy delivery run time; to avoid discharging battery units too deeply; to prevent battery units from overheating; and to respond quickly to detect overheated battery units, precipitous battery cell impedance drops, and other dangerous battery conditions which could result in battery cell damage or combustion.

The flow 100 includes reconfiguring 150 one or more battery units for battery unit replacement. Battery replacement can include removing a battery unit and replacing the battery unit with a second battery unit. A battery unit can require replacement for a variety of reasons. The battery units are formed from used, repurposed, recovered, and similar battery cells. The battery cells “age”, where the aging can be based on increasing charge leakage, exceeding useful lifespan based on charge/recharge cycles, physical degradation of the battery units, physical damage, and so on. Battery units, and the battery cells that form them, can require replacement when the battery unit performance characteristics fall below a usable level or threshold. The battery unit to be replaced can be replaced with a battery unit that is substantially similar to the battery unit being replaced or substantially dissimilar from the battery unit. The reconfiguring can further be associated with battery units that can be removed for maintenance, repair, servicing, etc. In embodiments, a to-be-replaced battery unit, from the plurality of battery units, can be controlled such that the switch pair of the to-be-replaced battery unit is opened, and the shunt switch of the to-be-replaced battery unit is closed. This switch configuration can electrically isolate the battery unit from the power bus to enable safe battery unit removal. Further embodiments can include reconfiguring the plurality of battery units to remove the to-be-replaced battery unit. The reconfiguring can include switching another battery unit with the battery system to provide energy to the battery system while the to-be-removed battery unit is removed and replaced. The battery system can be reconfigured after the replacement battery has been installed.

In addition to replacing one or more battery units, battery units can be removed or added to the battery system. Adding battery units to the battery system can be performed to increase battery system output voltage and/or current, to increase energy delivery run time, to resize the battery system based on changing energy load requirements, and so on. The flow 100 further includes additionally reconfiguring the plurality of battery units to add 152 a new battery unit. The new battery unit can be inserted into an open battery position within the battery system. Recall that a battery unit can be connected to a power bus by closing the switch pair and opening the shunt switch associated with the battery unit. The battery unit can be bypassed by closing the shunt switch and opening the switch pair associated with the battery unit. The new battery unit also can be connected to the signal communication path. In embodiments, the signal communication path of the new battery unit can be physically engaged before the new battery unit anode power connection and cathode power connection are made. In embodiments, the signal communication path of the new battery unit is physically engaged such that the new battery unit anode power connection and cathode power connection can be enabled by the master controller. Connecting the signal communication path before, or even at the same time, as the power connections can enable the master controller to configure the shunt switch and the switch pair prior to connect the battery unit to the power bus, thereby minimizing disturbance to the power bus and minimizing risk of damaging the battery unit that is being added to the battery system. In embodiments, the new battery unit anode power connection and cathode power connection are physically enabled or prevented under control of the master controller. When the added battery unit is to be used with the battery system, the master controller can set the shunt switch and the switch pair for battery unit use. In embodiments, the master controller can enable battery unit hot swap operation. Battery unit hot swap operation enables a battery unit to be removed, replaced, or added to the battery system without taking the battery system offline, shutting it down, etc. Instead, the battery system can remain in operation while the battery unit is replaced.

In the flow 100, a master controller replacement sequence is initiated 154 by a manual action on a battery unit to be replaced. Having identified a battery unit for replacement, the master controller can initiate or prevent battery unit replacement. The determination to initiate or prevent battery unit replacement can be based on an urgency for replacement such as a safety emergency battery unit replacement, whether an individual is authorized or trained for battery unit replacement, and so on. In embodiments, a master controller replacement sequence is initiated by a manual action on a battery unit to be replaced. A manual action can include reading a code such as a barcode visible on the battery unit, providing an access code, and so on. In embodiments, the manual action comprises pressing a button integrated in the battery unit to be replaced. Other actions can include sliding, rotating, extracting, etc. In the flow 100, the manual action is communicated 156 to the master controller using the signal communication path of the battery unit to be replaced. The communication can be based on a signal, text, and so on. The communication can be accomplished using a communications standard.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

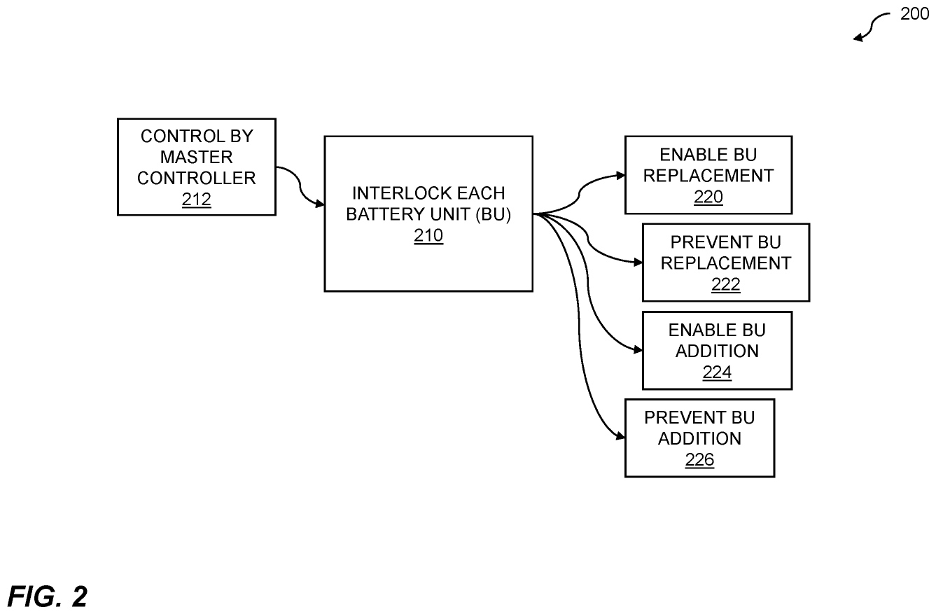

FIG. 2 is a flow diagram for battery unit handling. Discussed previously and throughout, battery unit handling can include battery unit replacement due to battery unit failure; diminished battery unit capabilities such as increased leakage, elevated temperature, or reduced battery cell impedance; and so on. The battery unit replacement can be initiated based on master controller recommendation, routine maintenance, an emergency, and the like. Battery unit handling supports a battery management system with controlled replacement. A plurality of battery units is configured, wherein each battery unit of the plurality of battery units is connected in series to a power bus through a switch in each anode power connection of each battery unit and through a switch in each cathode power connection of each battery unit, wherein the switch in the anode power connection of each battery unit and the switch in the cathode power connection of each battery unit comprise a battery unit switch pair, and wherein each battery unit switch pair is electronically controlled by a master controller. A power shunt switch is connected across each battery unit switch pair, wherein each power shunt switch is electronically controlled by the master controller, and wherein each power shunt switch enables the power bus to bypass a selected battery unit. A signal communication path is provided between the master controller and each battery unit. An in situ battery unit reconfiguration is effected, using the master controller.

Batteries included within a disparate battery system can be controlled. Rechargeable batteries, such as lithium-ion batteries that have been removed from vehicles, energy storage devices, personal electronic devices, and so on, can be reused for other applications. These second use batteries can be perfectly capable of functioning in certain capacities and usages. While the batteries may no longer meet their original specifications with respect to energy storage, leakage, and so on, the batteries can still store and provide energy for other applications. In order to use such “second life” batteries, the batteries can be disassembled down to their battery cells. The battery cells can be reassembled into battery units. Electronically controlled switches and scanners or sensors can be coupled to the battery unit. The switches can be used to couple, decouple, and bypass the battery cells, while the scanners and sensors can be used to monitor battery performance characteristics such as temperature, current, voltage, or impedance data. The switches, which are based on high-speed switching devices, and the scanners, which can include voltage, current, temperature, and impedance sensors, can be controlled in order to operate the battery units and battery systems at their most efficient and safest levels. The safe battery levels can be monitored by a failsafe system that monitors safe battery levels and selectively disconnects battery units from the battery system before a battery unit failure. The battery units and systems can be monitored frequently to quickly respond to any detected problems. The monitoring and response enable dynamic control.

The flow 200 includes physically interlocking 210 each battery unit of the plurality of battery units as part of the configuring. The physical interlocking of each battery unit can be performed by an electromechanical interlock. The electromechanical interlock can be based on a variety of techniques such as a solenoid-actuated interlock element. The interlock element can snap into a bracket associated with the battery unit, slide a rod, rotate a locking disk, rotate a threaded rod, and so on. In the flow 200, the electromechanical interlock is controlled 212 by the master controller. The master controller can activate the lock, deactivate the lock, check a status of the lock, etc. In embodiments, the master controller can analyze battery unit performance characteristics communicated in real time between the master controller and a local controller associated with a battery unit using a provided signal communication path. The master controller can determine that a battery unit has failed, has fallen below required energy storage and delivery levels, requires maintenance, and so on. The master controller can send an alert indicating that a battery unit requires replacement. The alert can include a flag or semaphore, a text message or email message, and the like. The alert can include details about a battery unit that requires replacement. In embodiments, a master controller replacement sequence can be initiated by a manual action on a battery unit to be replaced. A battery system technician or owner can identify the battery unit to be replaced and initiate the manual action associated with the battery unit. In embodiments, the manual action can include pressing a button integrated in the battery unit to be replaced. The button press can be detected by the local controller associated with the selected battery unit and forwarded to the master controller. In embodiments, the manual action can be communicated to the master controller using the signal communication path of the battery unit to be replaced. The manual controller can respond by deactivating the electromechanical interlock, thereby enabling the technician or owner to remove the battery unit. Some embodiments comprise physically interlocking each battery unit of the plurality of battery units as part of the configuring. In embodiments, the physical interlock is performed electromechanically.

Recall that the electromechanical interlocking of battery units can be part of configuring a battery system. The configuring can occur while the battery system is being installed; dynamically to address changing energy loads over time; as part of routine maintenance, battery replacement, or battery system configuration changes; and so on. The electromechanical interlocking can be used to enable, disable, limit, etc., the removal, replacement, and addition of battery units. In the flow 200, the electromechanical interlock can enable 220 battery unit physical replacement. Discussed above and throughout, the battery unit physical replacement can be initiated by a manual press of a button integrated into the battery unit to be replaced. Based on receiving an indication of the manual press, the master controller can determine that the button press indication is valid, that the individual pressing the button is authorized to handle the battery unit, etc. The master controller can enable battery unit replacement by deactivating the electromechanical interlock. In the flow 200, the electromechanical interlock can prevent 222 battery unit physical replacement. The master controller can determine that the button press was spurious, was received from a battery unit different from the battery unit indicated for replacement, was initiated by an unauthorized individual, etc. The battery unit replacement can comprise a partial replacement, where a battery unit is removed, but a new battery unit is not immediately added. In the flow 200, the electromechanical interlock can enable adding 224 a new battery unit. The electromechanical interlock can be deactivated such that a new battery unit can be installed in the battery system. The new battery unit can be placed into the battery system. The master controller can activate the electromechanical interlock to configure the new battery unit in the battery system. In the flow 200, the electromechanical interlock can prevent adding 226 a new battery unit. The preventing can be accomplished by activating the electromechanical interlock such that a new battery unit is blocked from physical installation in the battery system.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

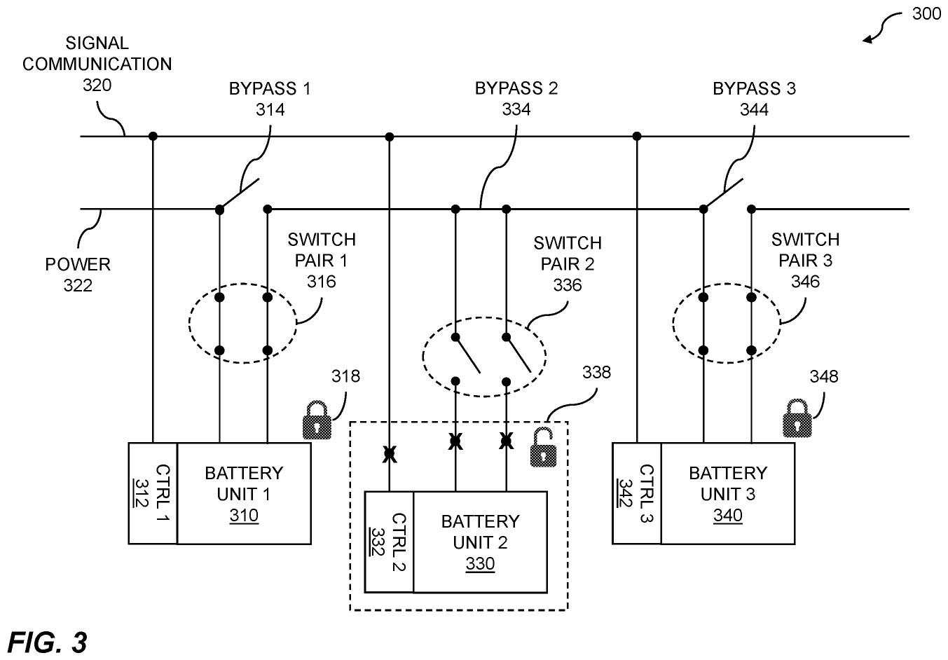

FIG. 3 shows battery unit replacement initiation and removal. At times, a battery unit within a battery system can be removed. The basis for the removal of the battery unit can include a battery unit failure, an out-of-specification condition, an elevated temperature alert, and so on. The removal of a battery unit can also be performed in order to replace the battery unit. Battery replacement initiation and removal is enabled by a battery management system with controlled replacement. A plurality of battery units is configured, wherein each battery unit of the plurality of battery units is connected in series to a power bus through a switch in each anode power connection of each battery unit and through a switch in each cathode power connection of each battery unit, wherein the switch in the anode power connection of each battery unit and the switch in the cathode power connection of each battery unit comprise a battery unit switch pair, and wherein each battery unit switch pair is electronically controlled by a master controller. A power shunt switch is connected across each battery unit switch pair, wherein each power shunt switch is electronically controlled by the master controller, and wherein each power shunt switch enables the power bus to bypass a selected battery unit. A signal communication path is provided between the master controller and each battery unit. An in situ battery unit reconfiguration is effected, using the master controller.

A battery system 300 comprises one or more configurable battery units. The battery units can be configured by actuating switches such as electronically controlled switches associated with the battery units. A first battery unit 1 310 can include one or more battery cells, where the battery cells can include rechargeable battery cells. The rechargeable battery cells can include cells based on a variety of rechargeable technologies. The battery unit further includes a local controller such as ctrl 1 312. The local controller can monitor sensors associated the battery unit, execute instructions provided by a master controller (not shown) to configure the battery unit, and so on. The local controller can be in communication with the master controller using a signal communication path 320. The signal communication path can enable communication between the battery unit and the master controller based on various communications techniques such as standards-based communications techniques using one or more of a wired, wireless, or fiber-based communications channel. The battery unit can further be selectively connected to a power bus 322. The power bus can provide power from one or more battery units associated with the power system to one or more power loads. The battery unit can include a bypass such as bypass 1 314. The bypass can be accomplished using a shunt switch, where the shunt switch can be operated by the master controller.

The battery unit can further include a switch pair such as switch pair 1 316. The switch pair can comprise a switch coupled to an anode power connection to a battery unit, and a switch coupled to a cathode power connection to a battery unit. In embodiments, the switch in the anode power connection of each battery unit and the switch in the cathode power connection of each battery unit comprise the battery unit switch pair. The battery unit switch pair can be electronically controlled by the master controller. In the degenerative case, one of the switches in the switch pair 316 is replaced by simply a wire, that is, only a switch in the battery unit anode or a switch in the battery unit cathode is present, and the other leg of the switch pair is a wire. The battery unit can include an interlock such as lock 318. The lock is shown in the locked position which indicates that the battery unit can be configured to provide power to the power bus, or can be bypassed using a shunt switch. The locked position can further indicate that the battery unit cannot be removed from the battery system without initiating a removal and replacement technique. Embodiments can further include electromechanically interlocking each battery unit of the plurality of battery units as part of the configuring. The configuring can be executed by the local controller based on instructions, commands, directions, etc., received from the master controller. In embodiments, the electromechanical interlock can be controlled by the master controller. The electromechanical interlock can be based on an electrically operated locking mechanism such as a solenoid-activated locking mechanism. In embodiments, the electromechanical interlock can enable battery unit physical removal and/or replacement, or can prevent battery unit physical removal and/or replacement. In addition to enabling or preventing battery unit physical removal and/or replacement, the electromechanical interlock can enable adding a new battery unit. The adding a new battery unit can enhance energy handling capabilities of the battery system. In other embodiments, the electromechanical interlock can prevent adding a new battery unit.

The example battery system comprises a second battery unit, battery unit 2 330, which can include one or more rechargeable battery cells. The second battery unit further includes a local controller, such as ctrl 2 332, which can monitor and configure the second battery unit. The local controller can be in communication with the master controller using the signal communication path 320. The battery unit can further be selectively connected to a power bus 322. The battery unit can include a bypass, such as bypass 2 334, which for battery unit 2 is in the bypass position. The battery unit can further include a switch pair such as switch pair 2 336, which for battery unit 2 is in the open position. The battery unit can include an interlock such as lock 338. The lock is shown in the unlocked position, which indicates that battery unit replacement has been initiated for battery unit 2. A battery replacement sequence can be controlled by the master controller. In embodiments, the master controller replacement sequence can be initiated by a manual action on a battery unit to be replaced. The manual action can include identifying a battery unit for replacement, selecting the battery unit, and so on. In embodiments, the manual action can include pressing a button integrated in the battery unit to be replaced. The manual action can include sliding a switch, rotating a switch, pulling out a button associated with a switch, etc. In embodiments, the manual action can be communicated to the master controller using the signal communication path of the battery unit to be replaced. In a usage example, the local controller can collect sensor data indicating that the battery unit associated with the sensor requires replacement. The master controller can determine that the battery unit requires replacement and can send a notice to a technician indicating the battery unit, the battery system, the location of the battery system, the position of the battery unit, etc. The technician can initiate battery unit replacement by pressing the button integrated into the battery unit requiring replacement.

The example battery system comprises a third battery unit, battery unit 3 340, which can include one or more rechargeable battery cells. The third battery unit further includes a local controller, such as ctrl 3 342, which can monitor and configure the third battery unit. The local controller can be in communication with the master controller using the signal communication path 320. The battery unit can further be selectively connected to the power bus 322. The battery unit can include a bypass, such as bypass 3 344. The bypass, which comprises a shunt switch associated with battery unit 3, is in the open position. The battery unit can further include a switch pair such as switch pair 3 346, which for battery unit 3 is in the closed position. In the degenerative case, one of the switches in the switch pair 346 is replaced by simply a wire, that is, only a switch in the battery unit anode or a switch in the battery unit cathode is present, and the other leg of the switch pair is a wire. The battery unit can include an interlock such as lock 348. The lock is shown in the locked position, which indicates battery unit can be configured to deliver energy to the power bus 322. Note that while the example battery system is shown with three battery units, other configurations can be implemented with a greater or lesser number of battery units.

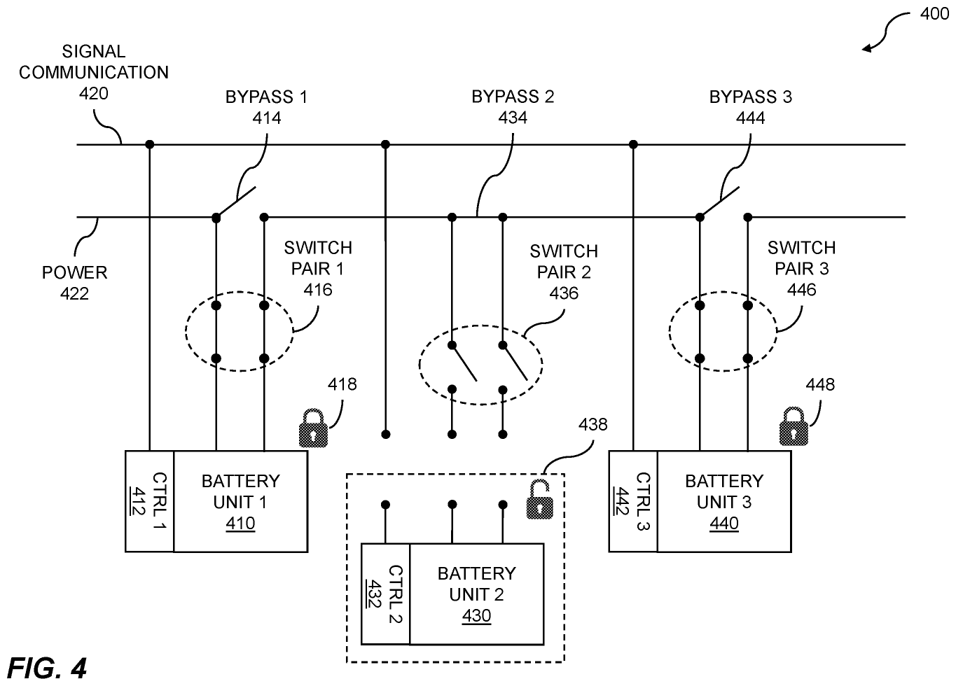

FIG. 4 illustrates battery unit replacement. A previous figure showed replacement initiation and removal for a battery unit associated with a battery system. The removed battery can be sent in for service, recycled, and so on. The removed battery unit can be replaced with a second battery unit. The battery unit for replacement can be a substantially similar battery unit or a substantially different battery unit. The illustration 400 shows a battery system comprising three battery units. The battery units can include battery unit 1 410. The battery unit includes a local controller such as crtl 1 412. The local controller can be in communication with a master controller (not shown) using a signal communication path 420. The battery unit can include switches, where the switches can include electronically controlled switches. The switches can include a shunt switch such as bypass 1 414, which can be used to bypass battery unit 1. The switches can further include a switch pair such as switch pair 1 416. The switch pair can comprise a switch in the anode power connection of the battery unit and a switch in the cathode power connection of the battery unit. The switches can be electronically controlled as a pair by the master controller. In the degenerative case, one of the switches in the switch pair 416 is replaced by simply a wire, that is, only a switch in the battery unit anode or a switch in the battery unit cathode is present, and the other leg of the switch pair is a wire. Configured as a switch pair, the switches can be both open or both closed to break or make connections to their respective battery unit terminals. In the case of battery unit 1, the shunt switch is open, and the switch pair is closed, thereby enabling connection of the battery unit to the power bus 422. The battery unit further includes a lock 418, where the lock can include an electromechanical interlock. The electromechanical interlock can lock the battery unit within the battery system during normal configuration and operation of the battery unit.

The battery system can further include a replacement battery unit 2 430. The replacement battery unit can replace a battery unit that was previously removed from the battery system. The battery unit includes a local controller such as crtl 2 432. The local controller can be in communication with a master controller (not shown) using a signal communication path 420. The battery unit can include switches such as electronically controlled switches. The switches can include a shunt switch such as bypass 2 434, which can be used to bypass battery unit 2. The switches can further include a switch pair such as switch pair 2 436. The switches comprising the switch pair can be electronically controlled by the master controller. In the degenerative case, one of the switches in the switch pair 446 is replaced by simply a wire, that is, only a switch in the battery unit anode or a switch in the battery unit cathode is present, and the other leg of the switch pair is a wire. In the case of battery unit 2, the shunt switch is closed, and the switch pair is open, thereby disabling and bypassing connection of the battery unit to the power bus 422. The battery unit further includes an electromechanical interlock 438. The electromechanical interlock is in the unlocked position, thereby readying the battery system for the new or replacement battery unit. The replacement battery unit can be inserted into the battery system. In embodiments, the signal communication path of the new battery unit can be physically engaged before the new battery unit anode power connection and cathode power connection are made. The connecting the communication path can enable registration of the new battery unit into the battery system. The connecting the communication path can further enable the master controller to configure the new battery unit. In embodiments, the new battery unit anode power connection and cathode power connection can be physically enabled or prevented under control of the master controller. The enabling or preventing can comprise configuration of the new battery unit. In embodiments, the master controller can enable battery unit swap operation. In embodiments, the battery unit swap operations comprise a hot swap battery unit operation. Battery unit hot swap operation enables replacement of a battery unit without having to shut down the battery system prior to the replacement of the battery unit.

The battery system can further include a third battery unit, battery unit 3 440. The battery unit 3 can include one or more rechargeable battery cells. The third battery unit further includes a local controller, such as ctrl 3 442. The local controller can monitor and configure the third battery unit. The local controller can be in communication with the master controller using the signal communication path 420. The battery unit can further be selectively connected to the power bus 422. The battery unit can include a shunt switch, such as bypass 3 444, which is in the open position. The battery unit can further include a switch pair such as switch pair 3 446, that is for battery unit 3 is in the closed position, thereby connecting battery unit 3 to the power bus 422. The battery unit can include an interlock such as lock 448. The lock is shown in the locked position, which indicates that battery unit can be configured to deliver energy to the power bus.

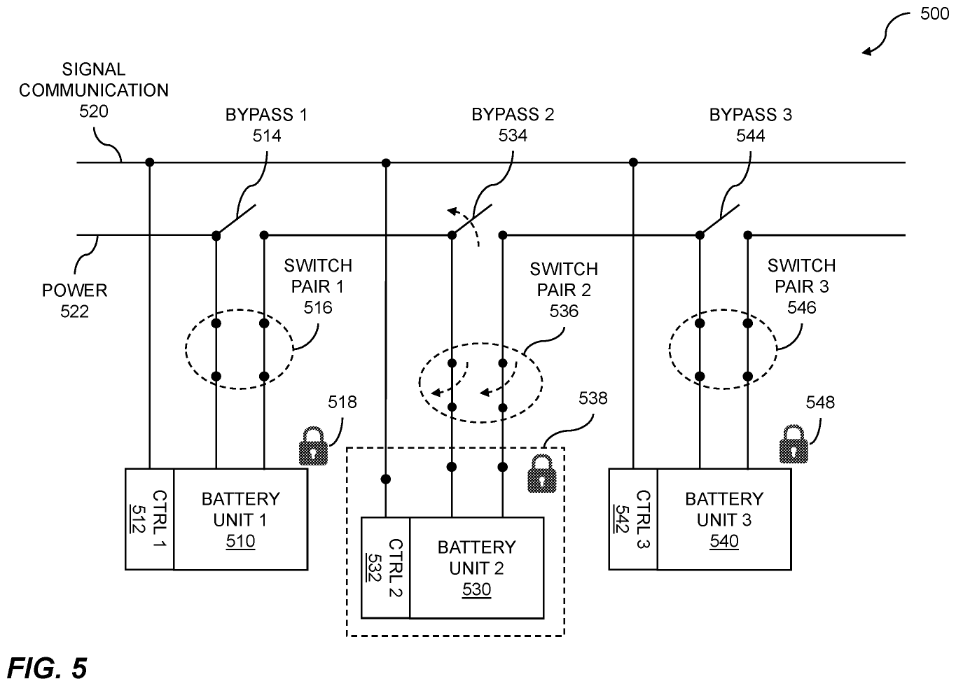

FIG. 5 shows battery unit replacement completion. Previous figures showed battery unit replacement initiation and removal, and battery unit replacement, respectively. A battery unit within a battery system can be replaced with a second battery unit. The battery unit replacement can be necessitated due to battery unit failure, battery cell combustion risk, routine maintenance, and so on. The replacement battery unit can be substantially similar to the replaced battery unit or substantially different from the replaced batter unit. The battery unit replacement completion can include configuring the placement battery unit for use within the battery system. FIG. 500 shows a battery system comprising three battery units, where replacement of one of the battery units has been completed. The battery units can include battery unit 1 510. The battery unit includes a local controller such as crtl 1 512. The local controller can be in communication with a master controller (not shown) using a provided signal communication path 520. The communication path can be wireless, wired, optical, etc. The battery unit can further include electronically controlled switches which are controlled by the master controller. The switches can include a shunt switch such as bypass 1 514, which can be used to bypass battery unit 1. The switches can further include a switch pair 1 516, where the switch pair can comprise a switch in the anode power connection of the battery unit and a switch in the cathode power connection of the battery unit. The switches can be electronically controlled as a pair by the master controller. In the degenerative case, one of the switches in the switch pair 516 is replaced by simply a wire, that is, only a switch in the battery unit anode or a switch in the battery unit cathode is present, and the other leg of the switch pair is a wire. Configured as a switch pair, the switches can be both open or both closed to break or make connections to their respective battery unit terminals. In the case of battery unit 1, the shunt switch is open, and the switch pair is closed, thereby enabling connection of the battery unit to the power bus 522. The battery unit further includes a lock 518 that can include an electromechanical interlock. The electromechanical interlock can lock the battery unit within the battery system during normal configuration and operation of the battery unit.

The battery system can further include a replacement battery unit 2 530. The replacement battery unit has replaced a battery unit that was previously removed from the battery system. The battery unit includes a local controller such as crtl 2 532. The local controller can be in communication with a master controller (not shown) using a signal communication path 520. The battery unit can include switches such as electronically controlled switches. The switches can include a shunt switch such as bypass 2 534, which can be used to bypass battery unit 2. The shunt switch can transition from closed to open under control of the master controller. The opening of the shunt switch can in part complete replacement of a battery unit. The switches can further include a switch pair such as switch pair 2 536. The switches comprising the switch pair can be electronically controlled by the master controller. In the degenerative case, one of the switches in the switch pair 536 is replaced by simply a wire, that is, only a switch in the battery unit anode or a switch in the battery unit cathode is present, and the other leg of the switch pair is a wire. In the case of battery unit 2, the switch pair can transition from open to closed, thereby enabling connection of the battery unit to the power bus 522. The shunt switch and switch pair transitions are accomplished by the master controller. In embodiments, the new battery unit anode power connection and cathode power connection can be physically enabled or prevented under control of the master controller by actuating the switch pair. The battery unit further includes an electromechanical interlock 538. The electromechanical interlock is transitioned from an unlocked to a locked position by the master controller, thereby completing battery unit replacement within the battery system.

The battery system 500 can further include a third battery unit, battery unit 3 540. The battery unit 3 can include one or more rechargeable battery cells. The third battery unit further includes a local controller, such as ctrl 3 542. The local controller can monitor and configure the third battery unit based on communications with the master controller. The local controller can be in communication with the master controller using the signal communication path 520. The battery unit can further be selectively connected to the power bus 522. The battery unit can include a shunt switch, such as bypass 3 544, which is in the open position. The battery unit can further include a switch pair such as switch pair 3 546, which for battery unit 3 is in the closed position, thereby connecting battery unit 3 to the power bus 522. In the degenerative case, one of the switches in the switch pair 546 is replaced by simply a wire, that is, only a switch in the battery unit anode or a switch in the battery unit cathode is present, and the other leg of the switch pair is a wire. The battery unit can include an interlock such as lock 548. The lock is shown in the locked position, which indicates that battery unit 3 can be configured to deliver energy to the power bus.

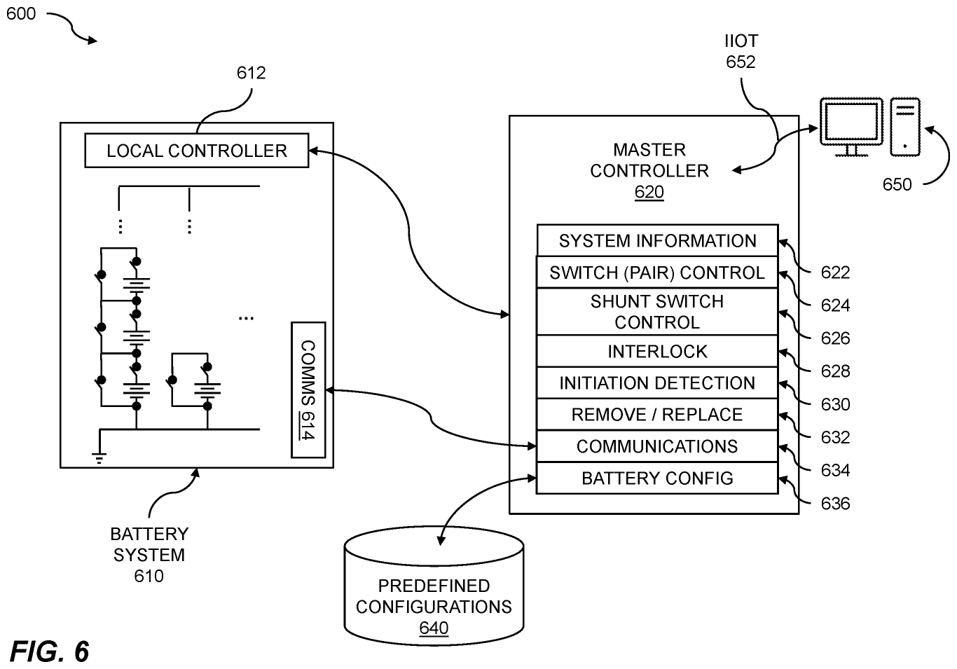

FIG. 6 is a system block diagram for managing controlled replacement. A master controller can be used to control a battery system. The battery system can comprise a plurality of battery units, where a battery unit can include one or more battery cells; switches; sensors such as thermal, voltage, and current sensors; and so on. In embodiments, each battery unit of the plurality of battery units can include a local controller for communicating with the master controller. The local controller can monitor sensors associated with the battery unit; send messages to the master controller; respond to commands, requests, etc. sent by the master controller; and so on. In embodiments, the local controller can sense battery unit performance characteristics. The local controller can process integrated button presses, actuate an electro-mechanical interlock component, etc., under control of the master controller. The local controller can communicate an event, such as a button press event, to the master controller, using the signal communication path. The button press event can indicate the battery unit to be replaced. The signal communication path can be based on one or more communications standards, protocols, etc. The master controller can communicate with devices, systems, and so on beyond the battery system. In embodiments, the communications beyond the battery system can be enabled by an Industrial Internet of Things (IIoT) protocol. A Battery Management System (BMS) can determine the battery system configuration based on power requests to the system. The requests can be made by a user or automatically by a system requiring energy coupled to the battery system. The BMS can configure the battery system by determining how to direct the switches such as software-controlled switches to couple specific battery cells to achieve the desired configuration. The BMS can further provide battery system status information using protocols such as secure TCP/IP protocols.

The system block diagram or arrangement 600 can include a battery system 610. The battery system is comprised of a plurality of battery units, where each battery unit can comprise a plurality of battery cells. The battery units are coupled to a plurality of software-controlled switches. In embodiments, each battery unit of the plurality of battery units can be connected in series to a power bus through a switch in each anode power connection of each battery unit and through a switch in each cathode power connection of each battery unit. The switch in the anode power connection of each battery unit and the switch in the cathode power connection of each battery unit comprise a battery unit switch pair, and each battery unit switch pair is electronically controlled by a master controller. The switches can couple the battery cells into a plurality of columns arranged in series. The switches can couple the columns in parallel, forming the battery system. The battery units can include rechargeable batteries such as lithium-ion batteries that have been removed from vehicles, energy storage devices, personal electronic devices, and so on, which can be reused for other applications. These batteries can be considered used, previously used, preowned, “second life”, etc. The battery system can include a local controller (LC) 612, which can determine whether a battery cell is usable, available, required, etc. by the system. In embodiments, the local controller senses battery unit performance characteristics. The performance characteristics can include battery unit storage capacity, energy delivery capabilities, internal temperature, combustion risk, and so on. The local controller can control the switches associated with the battery cells and battery columns to enable cells and columns, to bypass cells and columns, etc. The control of the switches can be orchestrated by a master controller (discussed below). The battery system can include a communications element 614. The communications element can be incorporated into the local controller, coupled to the local controller, etc. The communications element can communicate with the master controller. The communications element can use a signal communication path between the master controller and each battery unit. The communication path can include a wired, wireless, or fiber-based path.

The arrangement 600 can include a master controller (MC) 620. The MC can monitor and control operation of one or more battery systems. The MC can obtain battery system status information 622. The battery system status information can include state of battery unit charge; sensor data such as voltage, current, and battery cell temperature data; and so on. The MC can perform switch (or switch pair) control 624. The master controller can control anode power connection switch and cathode power connection switch pairs associated with the one or more battery units within the battery system. The switch pairs can connect a battery unit to a power bus. The connection of the battery unit to the power bus can be a series connection. The MC can control shunt switches 626 associated with the one or more battery units. A shunt switch associated with a battery unit can enable the power bus to bypass a selected battery unit. The shunt switch and the switch pair associated with a battery unit can be operated in tandem. In a usage example, the switch pair can be opened and the shunt switch can be closed to electrically isolate the battery unit from the power bus. The electrical isolation can be used to disconnect a battery unit when not in use, to prepare the battery unit for removal or replacement, etc.

The master controller can control interlocking 628 one or more battery units within the battery system. The interlocking can be used to enable or disable battery security, removal, replacement, addition, and so on. Further embodiments can include electromechanically interlocking each battery unit of the plurality of battery units. The interlocking can be part of configuring the battery system (discussed below). The interlocking can be accomplished using an electromechanical lock such as a solenoid actuated lock. The MC can include an initiation detection element 630. The initiation detection element can detect a signal, flag, message, etc., that can indicate initiation of a battery unit addition, removal, replacement, etc. The MC can enable removal and replacement 632 of battery units within the battery system. The removal and replacement of a battery unit can include a sequence such as a control sequence. In embodiments, a master controller replacement sequence can be initiated by a manual action on a battery unit to be replaced. The manual action can be performed by an individual. In embodiments, the manual action can include pressing a button integrated in the battery unit to be replaced. The manual action can include a sliding action, a rotating action, etc. The MC can enable communications 634. The communications can occur between the master controller and a communications element associated with a battery system. The communications can be based on standard electronic communications standards such as 802.11, Bluetooth™ Zigbee, etc.

The master controller can enable battery configuration 636. Battery configuration can include configuring one or more battery units within the battery system. The configuration can include configuring the battery system to provide a voltage, a current, and an amount of energy; a duration of time to provide voltage, current energy, etc.; and so on. The battery configuration can include connecting or disconnecting individual battery units within the battery system. The battery configuration can be based on one or more predefined battery configurations 640. The standard configurations can be based on voltage, current, energy, and so on. The standard configurations can be based on application. In a usage example, a predefined configuration can configure the battery system to provide backup power to a dwelling. An AC voltage can be obtained by coupling the battery system to an inverter (not shown).

The MC can effect in situ battery unit configuration, reconfiguration, and so on. In embodiments, the in situ battery unit reconfiguration can enable real-time power capability adjustment for the plurality of battery units. The real-time power capability adjustment can be based on periodic sampling of battery system capability, load requirements, and so on. In embodiments, the real-time power capability adjustment can provide matching between battery unit performance and battery management system load requirements. The MC can control adding a battery unit to a battery system, removing a battery unit, replacing a battery unit, etc. In embodiments, the master controller can enable battery unit hot swap operation. The MC can further operate physical retainment of battery units within a battery system. Further embodiments include electromechanically interlocking each battery unit of the plurality of battery units as part of the configuring. The electromechanical interlock is controlled by the master controller. The master controller can communicate with a communications device 650. The communications device can be remote from the master controller and can be employed by a user to communicate with the battery system. The communications device can comprise a computer, laptop, tablet, cellphone, PDA, and the like. In embodiments, the communications device is another battery system, power grid, charging station, etc. which can negotiate power requirements directly with the battery system. Communication between the communications device and the master controller can be accomplished using a variety of electronic communications techniques. The communication can be accomplished over an industrial grade hardware interface such as CAN, RS485, Modbus, etc. In embodiments, the MC enables an Industrial Internet of Things (IIoT) 652 capability for the battery system to enable business-to-business communications over the Internet.

Other communications protocols can be supported. The MC can support protocols such as Simple Object Access Protocol (SOAP), Representational State Transfer (REST), and so on. The MC can support queries from the communications device to the battery system. For example, the MC can support a query to supply system information. The system information can include battery cell profiles, system status, temperature, current, voltage, power cycle information, and so on. The MC can provide information based on a query of capabilities of the battery system. The capabilities can include features, number, and health of battery cells, voltage output range, power capacity of the battery system, total energy, and so on. The MC can also provide information based on a query on availability of output from the battery system. An availability of output query can include information on the readiness of the system, charging time required, time until a charge is needed, and so on. In cases where one of the battery cells in the battery system fails, has degrading performance characteristics, represents a safety risk, etc., the MC can decommission a battery cell, column, portion, region, etc. of the battery system. The decommissioning can disable one or more battery cells in the system. The MC can include the ability for a user or system to provide power request parameters to the battery system. The power request parameters can include voltage, power, total energy, external system operating requirements, internal system operating requirements, user settings, or user preferences.

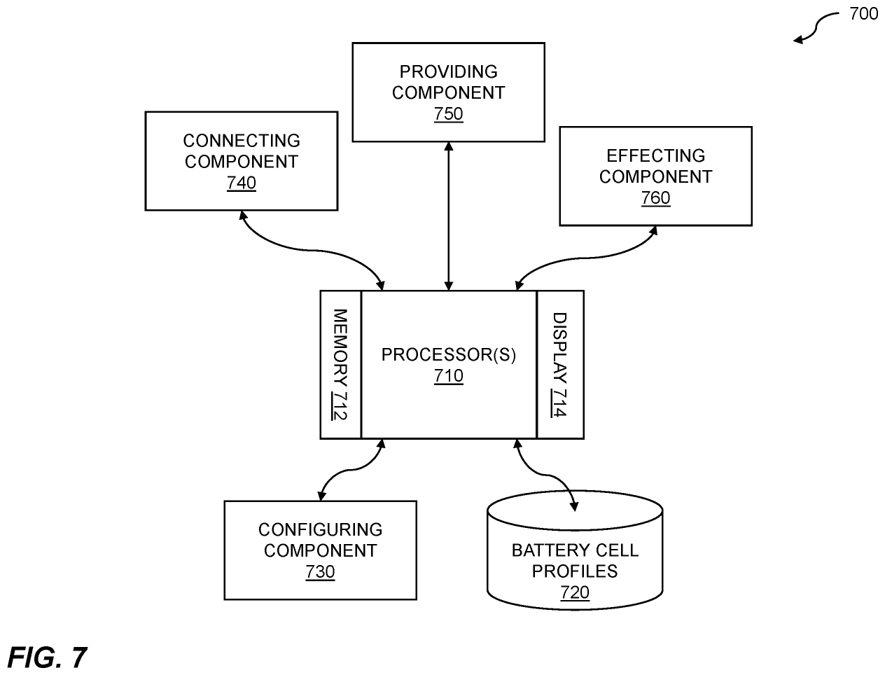

FIG. 7 is a system diagram for a battery management system. The battery management is enabled by controlled replacement of battery units. The system 700 can include one or more processors 710, which are attached to a memory 712 which stores instructions. The system 700 can further include a display 714 coupled to the one or more processors 710 for displaying data, intermediate steps, battery unit configurations, performance information, battery usability and capacity data, battery state, predicted capacity metric for a battery, remaining energy, and so on. In embodiments, one or more processors 710 are coupled to the memory 712, wherein the one or more processors, when executing the instructions which are stored, are configured to: configure a plurality of battery units, wherein each battery unit of the plurality of battery units is connected in series to a power bus through a switch in each anode power connection of each battery unit and through a switch in each cathode power connection of each battery unit, wherein the switch in the anode power connection of each battery unit and the switch in the cathode power connection of each battery unit comprise a battery unit switch pair, and wherein each battery unit switch pair is electronically controlled by a master controller; connect a power shunt switch across each battery unit switch pair, wherein each power shunt switch is electronically controlled by the master controller, and wherein each power shunt switch enables the power bus to bypass a selected battery unit; provide a signal communication path between the master controller and each battery unit; and effect an in situ battery unit reconfiguration, using the master controller.

The system 700 can include battery cell profile information 720. The battery cell profile information 720 can include data associated with batteries that can form battery units, which can in turn form the battery system. The battery cell information can include physical parameters associated with the batteries, such as size, shape, weight, terminal configuration, battery chemical type, and so on. The battery cell information can include battery cell manufacturer information, usage hours, battery cell temperature, and the like.

The system 700 can include a configuring component 730. The configuring component can configure a plurality of battery units. The configuring can include connecting battery units, disconnecting battery units, adding or replacing battery units, and so on. Each battery unit of the plurality of battery units is connected in series to a power bus through a switch in each anode power connection of each battery unit and through a switch in each cathode power connection of each battery unit. The anode power connection switch and the cathode power connection switch can include solid-state switches. In embodiments, the solid-state switch can include a circuit comprising one or more power MOS transistors. The switch in the anode power connection of each battery unit and the switch in the cathode power connection of each battery unit comprise a battery unit switch pair. Each battery unit switch pair is electronically controlled by a master controller. The master controller can control individual battery units, columns of battery units within a battery system, rows of battery units within the battery system, clusters of battery units, etc.

The system 700 can include a connecting component 740. The connecting component can connect a power shunt switch across each battery unit switch pair. Each power shunt switch is electronically controlled by the master controller, and each power shunt switch enables the power bus to bypass a selected battery unit. The bypassing a selected battery unit can be operated in coordination with the switch pair associated with each battery unit. In a usage example, the battery unit switch pair can be opened, and the bypass switch can be closed to electrically isolate the battery unit from the power bus, from other battery units, etc. The master controller can coordinate the opening of the battery unit switch pair and the closing of the shunt switch. The system 700 can include a providing component 750. The providing component can provide a signal communication path between the master controller and each battery unit. The signal communication path can include a wired path, a wireless path, and so on. The signal communication path can include an optical fiber path. The signal communication path can support one or more communications protocols such as 802.11 “WiFi”, IEEE-488, Zigbee™ Bluetooth™, near field communication (NFC), and the like.

The system 700 can include an effecting component 760. The effecting component can effect an in situ battery unit reconfiguration, using the master controller. Discussed previously and throughout, the master controller can reconfigure one or more individual battery units, rows or columns of battery units, groups of battery units, and so on. The reconfiguration can include adding, replacing, or removing battery units. In embodiments, the in situ battery unit reconfiguration can enable real-time power capability adjustment for the plurality of battery units. The reconfiguration can include reconfiguring battery system output voltage, current, runtime, etc. In embodiments, the real-time power capability adjustment can provide matching between battery unit performance and battery management system load requirements. The matching between battery unit performance and battery management system load requirements can be accomplished by adding or removing battery units, clusters of battery units, and so on. The adding and deleting battery units can be based on tracking changes in battery system load requirements and adjusting battery system capabilities dynamically. The tracking can be based on a capability and load requirement sampling frequency, on a percentage deviation between the capability and load requirements, etc.

Over time, battery units can lose their capacities to store energy and to deliver energy, can fail, can become combustion risks, and so on. In addition to connecting and disconnecting battery units using the battery unit switch pair, the configuring can include adding battery units, replacing battery units, removing battery units, and so on. In a usage example, a battery unit can be identified by the master controller as requiring replacement. The replacement determination can be based on battery cell temperature, battery unit leakage, and the like. In embodiments, a to-be-replaced battery unit, from the plurality of battery units, can be controlled such that the switch pair of the to-be-replaced battery unit can opened, and the shunt switch of the to-be-replaced battery unit can be closed. The opening of the battery unit switch pair and the closing of the shunt switch can be accomplished by the master controller. Further embodiments can include reconfiguring the plurality of battery units to remove the to-be-replaced battery unit. The reconfiguring can include substituting a spare or backup battery unit for the to-be-replaced battery unit during replacement. Further embodiments can include additionally reconfiguring the plurality of battery units to add a new battery unit. The new battery unit can be a substitute battery unit, a temporary replacement, a replacement, etc. In embodiments, the new battery unit can be controlled such that the switch pair of the new battery unit is closed, and the shunt switch of the new battery unit is opened.

Discussed previously, a battery unit can require replacement. The replacement can be necessitated by the battery being unable to hold charge or provide power, physical damage, combustion risk, and so on. Replacement of the battery can be managed by the master controller. In embodiments, a master controller replacement sequence can be initiated by a manual action on a battery unit to be replaced. The manual action can be based on identifying and selecting the battery unit to be replaced. In embodiments, the manual action can include pressing a button integrated in the battery unit to be replaced. The manual action can include toggling or sliding a switch, rotating a knob, etc. The manual action can cause a signal, flag, message, etc. to be sent to the master controller using wired, wireless, or fiber techniques. In embodiments, the manual action can be communicated to the master controller using the signal communication path of the battery unit to be replaced. The master controller can control physical removal or insertion of a battery unit into the battery system. Further embodiments can include electromechanically interlocking each battery unit of the plurality of battery units as part of the configuring. The removing a battery unit and replacing or adding a battery unit can be based on one or more removal or adding techniques. In embodiments, the signal communication path of the new battery unit can be physically engaged before the new battery unit anode power connection and cathode power connection are made. Recall that the anode power connection and cathode connection switches are controlled by the master controller. Engaging the signal communication path enables the master controller to control the anode and/or cathode switch associated with the battery unit. In embodiments, the new battery unit anode power connection and/or cathode power connection can be physically enabled or prevented under control of the master controller. The enabling the anode power connection and/or cathode power connection can couple the battery unit to the power bus. Disabling the anode power connection and/or cathode power connection can decouple the battery unit to the power bus. The disabling the anode and/or cathode switch can be accompanied by enabling the shunt switch associated with the battery unit to bypass the battery unit. In embodiments, the master controller can enable battery unit hot swap operation. The hot swap operation can be performed without shutting down the battery system of which the battery unit to be hot swapped is a part.

The system 700 can include a computer program product embodied in a non-transitory computer readable medium for battery management, the computer program product comprising code which causes one or more processors to perform operations of: configuring a plurality of battery units, wherein each battery unit of the plurality of battery units is connected in series to a power bus through a switch in each anode power connection of each battery unit and through a switch in each cathode power connection of each battery unit, wherein the switch in the anode power connection of each battery unit and the switch in the cathode power connection of each battery unit comprise a battery unit switch pair, and wherein each battery unit switch pair is electronically controlled by a master controller; connecting a power shunt switch across each battery unit switch pair, wherein each power shunt switch is electronically controlled by the master controller, and wherein each power shunt switch enables the power bus to bypass a selected battery unit; providing a signal communication path between the master controller and each battery unit; and effecting an in situ battery unit reconfiguration, using the master controller.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for a battery management system comprising:
configuring a plurality of battery units, wherein each battery unit of the plurality of battery units is connected in series to a power bus through a switch in each anode power connection of each battery unit and through a switch in each cathode power connection of each battery unit, wherein the switch in the anode power connection of each battery unit and the switch in the cathode power connection of each battery unit comprise a battery unit switch pair, and wherein each battery unit switch pair is electronically controlled by a master controller;
connecting a power shunt switch across each battery unit switch pair, wherein each power shunt switch is electronically controlled by the master controller, and wherein each power shunt switch enables the power bus to bypass a selected battery unit;
providing a signal communication path between the master controller and each battery unit; and
effecting an in situ battery unit reconfiguration, using the master controller.

2. The method of claim 1 wherein the in situ battery unit reconfiguration enables real-time power capability adjustment for the plurality of battery units.

3. The method of claim 2 wherein the real-time power capability adjustment provides matching between battery unit performance and battery management system load requirements.

4. The method of claim 1 wherein a to-be-replaced battery unit, from the plurality of battery units, is controlled such that the switch pair of the to-be-replaced battery unit is opened and the shunt switch of the to-be-replaced battery unit is closed.

5. The method of claim 4 further comprising reconfiguring the plurality of battery units to remove the to-be-replaced battery unit.

6. The method of claim 5 further comprising additionally reconfiguring the plurality of battery units to add a new battery unit.

7. The method of claim 6 wherein the new battery unit is controlled such that the switch pair of the new battery unit is closed and the shunt switch of the new battery unit is opened.

8. The method of claim 6 wherein the signal communication path of the new battery unit is physically engaged such that the new battery unit anode power connection and cathode power connection can be enabled by the master controller.

9. The method of claim 8 wherein the new battery unit anode power connection and cathode power connection are physically enabled or prevented under control of the master controller.

10. The method of claim 8 wherein the master controller enables battery unit swap operation.

11. The method of claim 10 wherein the battery unit swap operation comprises a hot swap battery unit replacement.

12. The method of claim 1 further comprising physically interlocking each battery unit of the plurality of battery units as part of the configuring.

13. The method of claim 12 wherein the physical interlock is performed electromechanically.

14. The method of claim 13 wherein the electromechanical interlock is controlled by the master controller.

15. The method of claim 13 wherein the electromechanical interlock enables battery unit physical removal and/or replacement.

16. The method of claim 13 wherein the electromechanical interlock prevents battery unit physical removal and/or replacement.

17. The method of claim 13 wherein the electromechanical interlock enables and/or prevents adding a new battery unit.

18. The method of claim 1 wherein a master controller replacement sequence is initiated by a manual action on a battery unit to be replaced.

19. The method of claim 18 wherein the manual action comprises pressing a button integrated in the battery unit to be replaced.

20. The method of claim 18 wherein the manual action is communicated to the master controller using the signal communication path of the battery unit to be replaced.

21. The method of claim 1 wherein each battery unit of the plurality of battery units includes a local controller for communicating with the master controller.

22. The method of claim 21 wherein the local controller senses battery unit performance characteristics.

23. The method of claim 22 wherein the battery unit performance characteristics are communicated in real time with the master controller using the signal communication path.

24. The method of claim 23 wherein the master controller initiates the effecting, based on the battery unit performance and a software-defined system goal.

25. A processor-implemented method for a battery management system comprising:
configuring a plurality of battery units, wherein each battery unit of the plurality of battery units is connected in series to a power bus through a switch in an anode power connection or a switch in a cathode power connection, of each battery unit, and wherein each battery unit switch is electronically controlled by a master controller;
connecting a power shunt switch across each battery unit switch and corresponding battery unit, wherein each power shunt switch is electronically controlled by the master controller, and wherein each power shunt switch enables the power bus to bypass a selected battery unit;
providing a signal communication path between the master controller and each battery unit; and
effecting an in situ battery unit reconfiguration, using the master controller.

26. A computer program product embodied in a non-transitory computer readable medium for battery management, the computer program product comprising code which causes one or more processors to perform operations of:
configuring a plurality of battery units, wherein each battery unit of the plurality of battery units is connected in series to a power bus through a switch in each anode power connection of each battery unit and through a switch in each cathode power connection of each battery unit, wherein the switch in the anode power connection of each battery unit and the switch in the cathode power connection of each battery unit comprise a battery unit switch pair, and wherein each battery unit switch pair is electronically controlled by a master controller;
connecting a power shunt switch across each battery unit switch pair, wherein each power shunt switch is electronically controlled by the master controller, and wherein each power shunt switch enables the power bus to bypass a selected battery unit;
providing a signal communication path between the master controller and each battery unit; and
effecting an in situ battery unit reconfiguration, using the master controller.

27. A computer system for battery management comprising:
a memory which stores instructions;
one or more processors coupled to the memory, wherein the one or more processors, when executing the instructions which are stored, are configured to:
configure a plurality of battery units, wherein each battery unit of the plurality of battery units is connected in series to a power bus through a switch in each anode power connection of each battery unit and through a switch in each cathode power connection of each battery unit, wherein the switch in the anode power connection of each battery unit and the switch in the cathode power connection of each battery unit comprise a battery unit switch pair, and wherein each battery unit switch pair is electronically controlled by a master controller;
connect a power shunt switch across each battery unit switch pair, wherein each power shunt switch is electronically controlled by the master controller, and wherein each power shunt switch enables the power bus to bypass a selected battery unit;
provide a signal communication path between the master controller and each battery unit; and
effect an in situ battery unit reconfiguration, using the master controller.
